(19) United States
(12) Patent Application Publication
(10) Pub. No.: US 2009/0259534 A1
(43) Pub. Date: Oct. 15, 2009

(54) INTERNAL BUSINESS ARBITRAGE

(75) Inventors: Brian James Utter, Seattle, WA (US); Alexander G. Gournes, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/101,887

(22) Filed: Apr. 11, 2008

(51) Int. Cl. G06Q 30/00; G06Q 20/00; G06Q 10/00

(52) U.S. Cl. 705/14; 705/39; 705/400

(57) ABSTRACT

System(s) and method(s) are provided to conduct internal arbitrage within an organization. Within a service platform, a first functional unit oriented to service implementation and a second unit dedicated at least in part to advertisement management trade advertisement trade, the first unit and the second administer advertisement within a first and a second pricing model. Internal arbitrage profits result from the advertisement transaction when the second unit commercialized advertisement with an external advertiser. A pricing conversion component facilitates mapping a first price proposition for an advertisement within the first pricing model to a second pricing proposition for the advertisement within the second pricing model. Internal arbitrage profits can be directed towards financing an intent-based consumer price incentive scheme.

### TECHNICAL FIELD

The subject specification relates generally to business arbitrage and, more particularly, to internal arbitrage within an organization that directs arbitrage profits towards financing a consumer price incentive scheme.

### BACKGROUND

A business opportunity in arbitrage can take place when there are two or more pricing models. An exchange can be created wherein a first pricing model is adopted in a business operation and then the pricing model is switched to a second pricing model with intent to derive a profit. As an example, arbitrage can take place when a trader acquires currency in a regulated market and sells the currency in a fluctuating market. Such a currency trading can lead to arbitrage profits. Generally, commercial transactions of a financial instrument (e.g., bonds, securities, currencies) in disparate markets with disparate conditions can lead to arbitrage profits. Conventionally, the disparity in markets drives profits in arbitrage, since buy/sell operations can be optimized for a specific set of conditions governing each of the markets that establish pricing models.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject innovation provides system(s) and method(s) to conduct internal arbitrage within an organization. The arbitrage arises from the coexistence of at least two pricing models for advertisement within a service platform, for example “cost per click” and “cost per action.” At least two functional units within the service platform commercialize tradable instruments like advertisement space. In an aspect, a first functional unit oriented to a service implementation and a second unit dedicated at least in part to advertisement management trade advertisement trade, the first unit and the second administer advertisement within a first and a second pricing model. Internal arbitrage profits result from the advertisement transaction when the second unit commercializes advertisement with an external advertiser. To facilitate commercialization with the external advertiser, a pricing conversion component facilitates mapping a first price proposition for an advertisement within the first pricing model to a second pricing proposition for the advertisement within the second pricing model. Internal arbitrage profits can be directed towards financing an intent-based consumer price incentive scheme.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a block diagram of an example that exploits internal arbitrage in accordance with aspects disclosed in the subject specification.

FIG. 2 is a block diagram of an example embodiment of a pricing conversion component in accordance with aspects described in the subject specification.

FIG. 3 illustrates an example embodiment of an optimization component in accordance with aspects described herein.

FIG. 4 illustrates an example system that compensates an agent through ad spend in exchange for the agent's intent in accordance with aspects disclosed in the subject specification.

FIG. 5 is a block diagram of an example advertisement management component that facilitates compensation credit(s) generation and advertisement delivery according to aspects described herein.

FIG. 6 is a block diagram of an example embodiment of compensation component in accordance with aspects described herein.

FIG. 7 is flowchart of an example method for performing an internal arbitrage according to aspects disclosed in the subject specification.

FIG. 8 is a flowchart of an example method for converting a first price proposition in a first pricing model to a second pricing proposition in a second pricing model according to aspects described herein.

FIG. 9 presents a flowchart of an example method for compensating an agent in exchange of the agent's commercial intent according to aspects set forth in the subject specification.

FIG. 10 presents a flowchart of an example method for compensating an agent through advertisement in exchange of agent's intent in transacting with a service platform in accordance with aspects described herein.

FIGS. 11 and 12 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

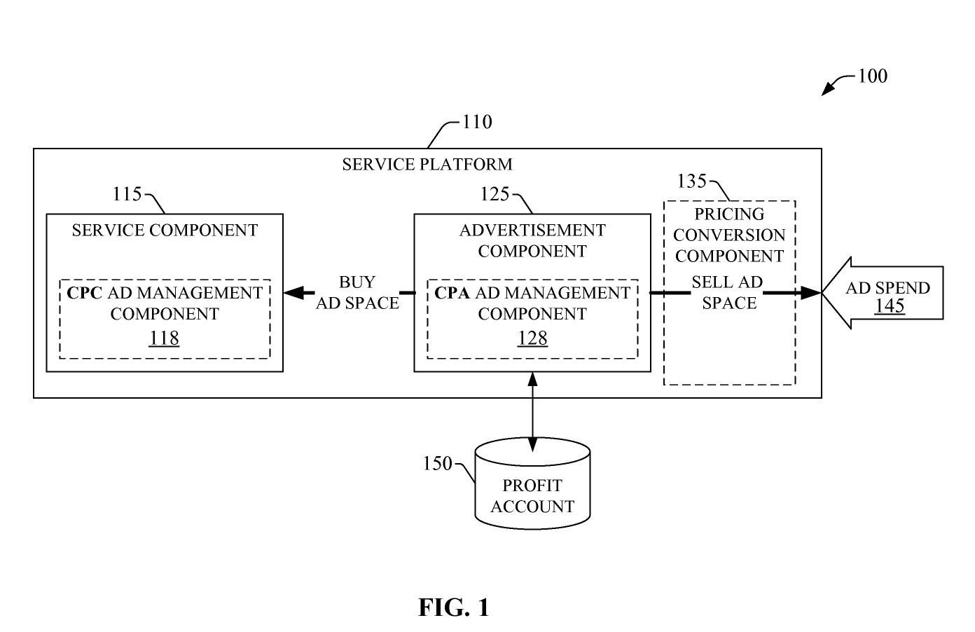

Referring initially to FIG. 1, a block diagram of an example system 100 the conducts arbitrage is illustrated. In example system 100, arbitrage is illustrated with respect to advertisement facilitated by a service platform 110 and two pricing models: “cost per click” (CPC) and “cost per action” (CPA). It should be appreciated that other pricing models can be contemplated, such as “cost per impression” (CPM). Service platform 110 includes a service component 115 which typically provides with a specific service implementation; e.g., a search engine; a web portal; a translation service; a polling website; a hotel, flight or rental-car reservation; and so on. It should be appreciated the service component 115 is not limited to online service implementations. Service component 115 includes a CPC advertisement management component 118 that administers advertisement within a CPC pricing model. Advertisement space offered within the CPC is bought from service component 115 by advertisement component 125, which is an integral part of service platform 110. Advertisement component 125 facilitates advertisement within service platform 110 and adopts a CPA pricing; CPA advertisement management component 128 controls advertisement operations. It is to be noted that commercialization of advertisement space among service component 115 and advertisement component 125 is internal to service platform 110. Thus, such commercial transaction offers the opportunity of internal arbitrage with the possibility of profit generation. In an aspect, profit generate through arbitrage by advertisement platform results from selling the acquired advertisement space within a CPA pricing model to an advertiser (not shown in FIG. 1). A pricing conversion component 135 transforms an original CPC proposition for a specific advertisement space into a CPA price proposition, which is the pricing model presented to an advertiser. Once a CPA price proposition is accepted, typically through a bid process, advertisement spend 145 is received. As mentioned above, profits resulting from selling CPA advertisement space bought within CPC are directed to profit account 150.

It is to be appreciated that other components (not shown) of service platform 110 can exploit arbitrage opportunities. For example, a gaming business operation managed by service platform 110 can buy CPC advertisement from a service component that streams advertisement to online or console games, and can sell the advertisement within CPA to a music records label to facilitate advertising music artists from the label during game play.

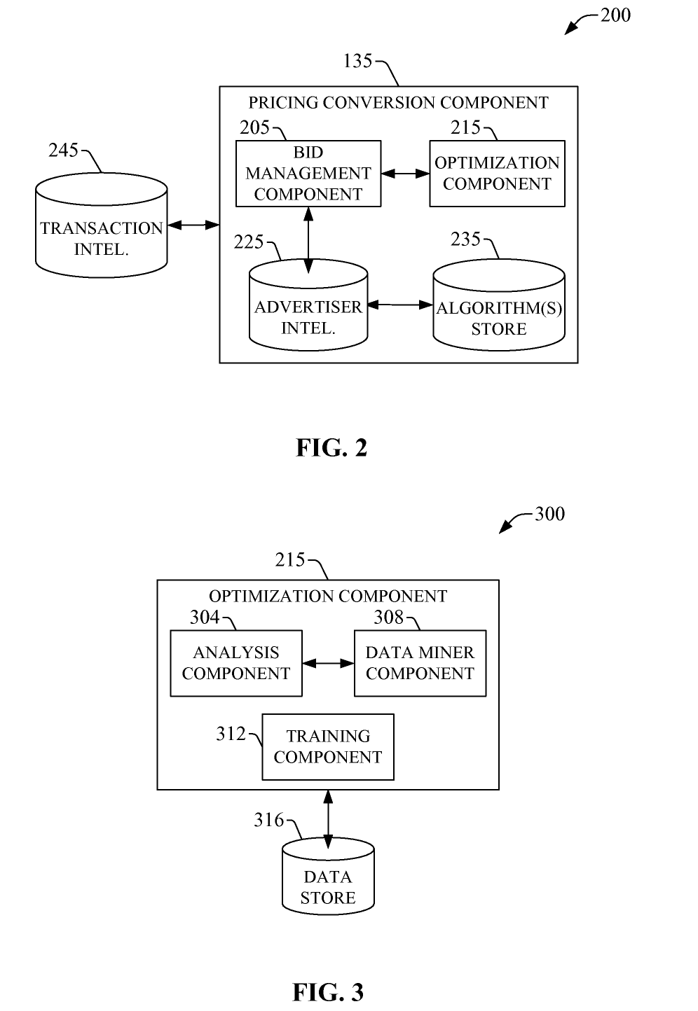

FIG. 2 illustrates an example embodiment 200 of a pricing conversion component 135. In embodiment 200, to effect a price proposition conversion from a first pricing mode (e.g., CPC) to a second pricing model (e.g., CPA) a bid management component 205 maps “clicks” volume for an advertisement unit to a likelihood of a transaction or “action” for the advertisement unit. Various factors associated with ad unit can define the mapping such as for example advertisement format (e.g., static, animated, interactive, amount of display real state utilized, audiovisual indicia utilized, and so on); position within a display resource, device in which the advertisement is to be displayed; and so on. In addition, “softer” factor can be included such as market or consumer segment targeted, time ad unit is to be displayed (e.g., presenting a newspaper advertisement in the evening may be less advantageous than presenting in the morning), brand or product advertisement; socioeconomic “mood” for advertised product or service, e.g., advertisement of “green,” energy efficient or conscious products like solar panels or hybrid cars can be more likely to elicit a consumer action than an ad unit for a “gasoline guzzler” vehicle; and so forth. To implement a mapping between a price proposition in a first pricing model to a second pricing proposition in a second pricing model, multiple algorithms can be utilized, such algorithms reside typically in a memory like store 235. Generally the algorithms can implement simulations of consumer and market behavior, such simulation can be based for example on classic and evolutionary game theory, neuroeconomic models, econophysics formalism, socio-economics, and inference based on utility analysis and historic data on advertisement transactions (e.g., transaction intelligence 245) and previous mappings among price propositions within disparate pricing models, as well as intelligence on advertiser(s), e.g., advertiser intelligence 225, that acquires the ad unit.

In an aspect, and optimization component 215 can exploit available historic data and simulation functionalities to optimize price conversion according to various economic objectives; namely, maximize profit or mitigate risk for advertisement component 125; to mitigate risk for an advertiser (e.g., the advertiser is an integral part of the service platform 110); to maximize utility of a device's set of media resources, maximize advertisement response in specific customer segment(s). It is to be appreciated that depending on optimization goal, mapping among pricing proposition(s) can differ. It is to be further appreciated that multiple economic objectives can be optimized simultaneously.

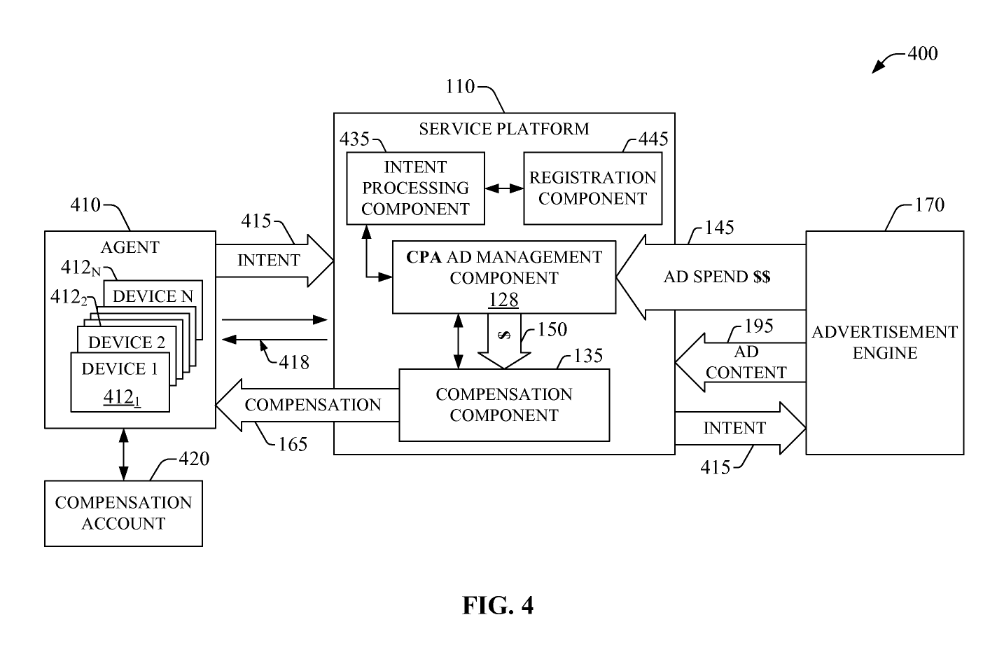

FIG. 3 illustrates an example embodiment of an optimization component 215 in accordance with aspects describe above. Optimization component 215 can reason, or draw conclusions, about an advertiser's economic objectives when advertising or advertisement platform (e.g., advertisement component 125) financial goals, when commercializing advertisement space, based at least in part on extrinsic data 316 (e.g., market conditions, advertisement response for specific customer segments, current fashion trends, degree of adoption of advanced technologies according to consumer segment(s) . . . ) available to service platform 110, and on advertiser intelligence 225 which can generally be collected at a time an advertiser engages an advertisement platform such as advertisement component 125.

Intelligent component 215 can generate a probability distribution of specific price conversions from a first pricing model (e.g., CPC) to a second pricing model (e.g., CPA). To infer advantageous conversions or mappings, or suitable adjustments to a value-cost proposition associated with the commercialized ad unit, e.g., a non-ideal mapping (e.g., a mapping based on transaction intelligence 245 with limited granularity) is established for the conversion and in exchange the advertiser receives a specific number of ad impressions free of charge formatted for a set of devices chosen by the advertiser, optimization component 215 relies on artificial intelligence techniques, which apply advanced mathematical algorithms—e.g., decision trees, neural networks, regression analysis, principal component analysis (PCA) for feature and pattern extraction, spectral analysis such as wavelet expansions, cluster analysis, genetic algorithms, and reinforced and supervise machine learning—to a set of available information such as advertiser intelligence 225, transaction intelligence 245, extrinsic data 316, and so on.

In particular, optimization component 215 can employ one of numerous methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

In example embodiment 300, analysis component 304 can execute at least a portion of the algorithms cited above for inferring price conversions among disparate price models. In addition, algorithm and computational resources can reside in analysis component 304, such as Monte Carlo simulations, game theoretic models (game trees, game matrices, pure and mixed strategies, utility algorithms, Nash equilibria, evolutionary game theory, etc.) of reward markets and advertiser behavior, and so on. Such resources generally complement algorithms available through store 235. Data miner 308 can further support analysis of information through data segmentation, model development for agent's behavior simulation(s) and related model evaluation(s) (e.g., generation of lift charts for discrete and continuous variables). Training component 312 utilizes available market and advertiser data and intelligence for machine learning (e.g., supervised, unsupervised, or reinforced) to autonomously develop mappings for price propositions between disparate pricing models. As available information increases, training results in improved performance of optimization component 212 and components, e.g., pricing conversion component 135, that utilize it.

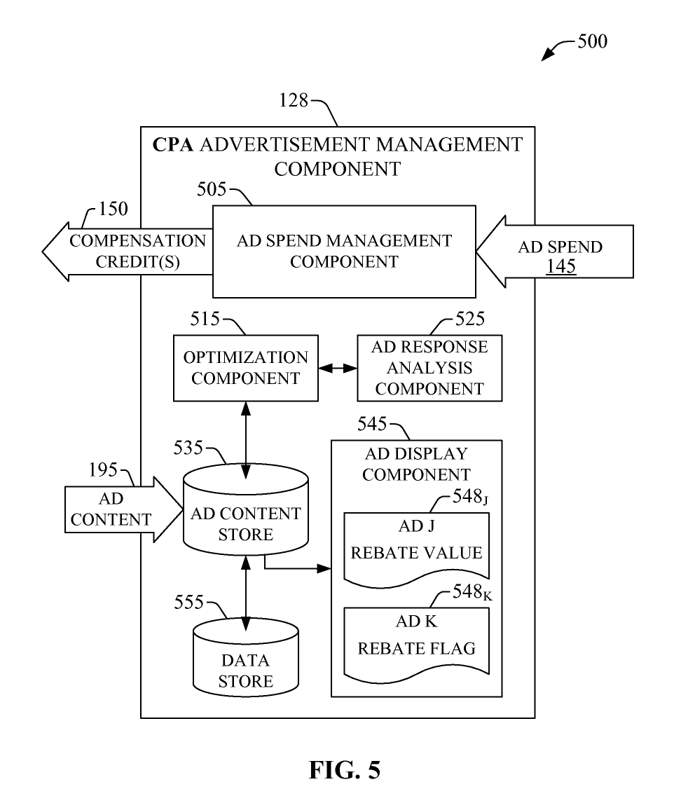

FIG. 4 illustrates an example system 400 that compensates an agent through ad spend in exchange for the agent's intent in accordance with aspects disclosed in the subject specification. In example system 400, agent 410 conveys a commercial intent 415 to service platform 110 (a portion of components illustrated in FIG. is not reiterated in FIG. 4), which compensates agent 410, via compensation 165, in return for the agent's conveyed intent 415. It should be appreciated that while a single agent 410 is illustrated, multiple customers can be included in agent 410. It is to be further appreciated that the commercial nature of agent's intent 415 lies in the fact that the intent 415 reveals the underlying purpose (e.g., purchasing a merchandise, selecting or subscribing to a service or product, utilizing a software application, requesting/accessing for specialized advise, and so on) of accessing service platform 110 and constitutes a key to receiving service from it—Agent 410 discloses intent 415 based on an expectation that the service platform 110 may be relevant to the agent's needs. By effecting such compensation, service platform 110 creates a monetary differential in favor of the customer, e.g., a user price incentive, and can distinguish itself from competitors. Such a distinction can occur at different levels: brand recognition, service/product demand, engagement of early adopters, potential for formation of business partnerships, and so on.

Service platform 110 is neither limited to a specific industry nor a specific service. Additionally, industry or service is neither limited services consumed online (e.g., through the Internet) nor offline (e.g., access to the service does not hinges on access to the Internet). A desirable characteristic of a service, or product obtained through service platform, is that the service is primarily accessed regularly (e.g., on a daily basis). Agent's intent 415 and the service provided, or goods delivered, by service platform 110 typically are interdependent. Online service platform.—In an aspect, service platform 110 can be an online search engine, wherein the search query embodies the agent's intent in receiving a list of search results. Moreover, customer intent 115 can be related to searching for a provider or particular goods or services, and a plurality of providers may compete for knowledge of such intent (e.g., by offering rewards/incentives) in order to be presented to the customer in a favorable forum/light that will facilitate a commercial transaction transpiring between the customer and the service or product provider. In another aspect, service platform 110 can be an online portal of a technical journal, where an agent looking to retrieve a specific article provides a citation to the article (e.g., intent 415) and the publisher responds by presenting or delivering the article to the user. In another aspect, service platform 110 can be an online software application service wherein an interface customized for an agent provides the functionalities of a specific software application (e.g., payroll and benefits applications; business development and program management applications, simulation applications; online gaming applications; and so on) for a service fee. In yet another embodiment, service platform 110 can be social networking website, wherein the service platform facilitates (i) customer expression through deployment and maintenance service(s) of a webpage, and (ii) interactions among disparate customers. It should be appreciated that various additional online services can be contemplated.

Offline service platform.—Substantially any merchant or service provider that operates offline can adopt the intent-compensation paradigm described herein; for instance, car and motorcycle dealers, department stores, coffee shops, liquor stores, bookstores, and so on.

Agent 410 can utilize various devices 412₁-412_{N}, which can either be wired or wireless (e.g., a cell phone, a laptop, tethered computer, vehicular navigation device, game console, or personal digital assistant) and with a display area that can be accessed interactively or otherwise, to convey intent 415. Based at least on disclosed information, the conveyed agent's intent 415 can be classified in at least two broad categories: (a) explicit expression of intent, and (b) implicit expression of intent. To convey intent and participate in the intent-compensation commercial scheme established in example system 400, an agent registers with system platform 430 through registration component 445, which gathers agent intelligence during the registration process. In addition, the agent also registers the set of devices 412₁-412_{N}. Registration of devices 412₁-412_{N} facilitates delivery of compensation and customized information related therewith such as advertisement, compensation opportunities, merchants affiliated with service platform 430 that participate in the intent-compensation commercial model, and so on. In addition to the benefits for the user in connection with participating in the intent-compensation price incentive model of service platform 110, registration with service platform 430 is also advantageous as agent intelligence can be collected at the time of registration, and utilized by service platform 430, for example, for targeted marketing campaigns.

Service platform 110 also includes an intent processing component 435 that obtains agent's intent 415 through a variety of instruments or mechanisms (e.g., portals, pop-up windows, queries, statements, utterances, inferences, extrinsic evidence, historical data, machine learning systems, webcams, charge-coupled device (CCD) cameras, microphones, feature harvesting systems, and so forth). Intent processing component 435 can evaluate the veracity of the agent intent 115 and generate confidence metrics associated therewith. Such confidence metrics can be factored in connection with allocation of compensation 165. It should be appreciated that, unlike conventional couponing and rebate schemes, intent processing component 435 determines or infers customer intent dynamically (for example via Internet or wireless communications—e.g., search engines and cellular telephones are examples of platforms suitable to deploy various embodiments described herein), and utilizes the determined intent to facilitate joining the agent with advertisers and, alternatively or additionally, suitable service providers (not shown) affiliated with service platform 110 in connection with maximizing utility to the user or the service provider. In addition, intent processing component 435 provides agent 410 with bargaining power through solicitation of intent information (the solicitation can occur through a wireless, wired, or hybrid communication link 418) which conventionally was often provided for free by an agent (e.g., agent 410). As a result, agents can increase buying power or wealth through leveraging off the value of their respective intent information. Furthermore, a filtering process can be achieved where unmotivated service providers or merchants, or respective advertiser, are not exposed to the agents thereby mitigating spam-like solicitations. An embodiment for intent processing component is discussed below.

In illustrative system 400, intent processing component 435 receives intent 415 from an agent 410. Intent 415 can be gleaned from information received from agent 410 in connection with a commercial intention in engaging a service platform 110 (e.g., a merchant, a service provider, or a content provider). Information is typically received by intent processing component 435 through communication link 418. As indicated above, communication link 418 can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. In addition, information can be intrinsic, e.g., conveyed by agent 410, or extrinsic, wherein intent processing component 435 collects information associated with agent 410 actions with respect to a service platform (e.g., service platform 410). To collect information, intent processing component 435 can exploit a variety of instruments and devices such as web cameras, infrared-visible cameras, CCD cameras sensitive to specific radiation frequencies, microphones, biometric pads, physiological sensors, positioning systems (e.g., Global Positioning System (GPS), Galileo, GLONASS), and associated wired and wireless transceivers that can communicate the gathered information.

Collected information compatible with privacy regulations, or policies, can be utilized by intent processing component 435 to infer agent's intent 415 through, for example intelligent component 225. Analysis and feature or pattern mining of information can be implemented by intelligent component 225 to extract agent's intent.

In an aspect, compensation 165 can be provided through advertisement; e.g., subsidized through advertisement revenues that result from ad spend 185, and offered via ad content 195 generated by advertisement engine 170. Compensation of an agent (e.g., agent 410) through a direct payment or an allocation of reward points can be delivered (via communication link 418) to a compensation account 420 that belongs to the agent. Service platform 110 includes a CPA advertisement management component 128 that operates as described above. In addition, CPA ad management component can utilize a known (through explicit intent expression) or established (e.g., extracted from an implicit expression) agent's intent 415 to generate advertisement impressions that carry a compensation in exchange of the customer intent. Compensation can be accessed through advertisement in multiple manners: (1) Advertisement exposure. In this scenario, the advertisement impression is conveyed to the user in the form of direct compensation, wherein the advertisement is a “conduit” for delivering the compensation. (2) Advertisement instantiation. A compensation is received by instantiating the advertisement impression; e.g., by following instructions in the advertisement such as for example, responding to an online or telephonic survey; visiting an online webpage or an offline showroom, watching a movie trailer or portion of a movie soundtrack, and so on. (3) Advertisement-driven action. Compensation is the result of a specific commercial transaction, or action, between the agent and the advertiser. It is to be appreciated that intent-driven advertisement is intrinsically targeted, thus the likelihood of an agent engaging in a transaction (e.g., an action) with the advertiser or service platform is substantially high, thereby the determination to utilize a pricing model based on “click per action” for transactions effected online. For online transaction a mapping between CPA and a disparate pricing model can be performed via pricing conversion component in the manner discussed above. The likelihood of an agent 410 take action can be biased via the level of provided compensation; namely, CPA advertisement management component 128 can present advertisement that offers a compensation 165 that is above a known or inferred engagement threshold (or value-cost proposition) associated with the agent that conveys the intent 415. In an aspect, this mode for accessing compensation can supplement (1) or (2).

As discussed above, to finance compensation (e.g., compensation 165) to a customer (e.g., agent 410) in exchange for the customer's intent (e.g., intent 415), service platform 430, through CPA ad management component 455, can direct funds from profit account 150 arising from internal arbitrage among service component 110 an advertisement component 125 (not shown in FIG. 4) that comprises CPA ad management component 128. The amount of funding 150 directed towards compensation is typically determined according to a financial, game-theoretic model that ensures a zero-sum scenario with respect to (a) advertisement revenue and external funds directed towards compensation; (b) ad spend 145 for advertisement campaigns; and (c) credit awarded for advertising to advertisement engine 170 by service platform 110 over an advertisement cycle (e.g., a week, a month, a quarter, . . . ). It is to be noted that (c) can be viewed as funds that “prime the pump” for an advertisement engine 170, by providing subsidies for advertisement campaigns in emerging markets; focused on new products or services; or based on new advertising techniques, resources and media. In addition, advertisement credits also facilitate exposure of advertisers to the subsidized-compensation commercial model without an upfront financial commitment. The latter can facilitate early adoption of the intent-based compensation program funded through arbitrage profit 150.

Once an advertisement model, or instrument, for compensation delivery is selected; based at least in part on the nature—explicit or implicit expression—of the intent 415 received by service platform 430, the available intelligence on the originating agent, etc.; and consistent action has been taken by a customer (e.g., agent 410), compensation component 135 delivers compensation 165. To that end, as discussed above, compensation component 135 performs multiple tasks, which comprise accounting, managing fraud, and retaining records associated with compensation. In an aspect, compensation component 135 can manage issued compensation like adopting changes to face-value of compensation 165; for instance, conferring a promotional value, typically above average or generally awarded value, to the compensation 165 if specific actions are taken by an agent like responding to an online product survey or visiting an offline store show-room within a specific period of time. In another aspect, compensation component 135 can determine specific compensation according to agent intelligence available to service platform 110, in order to mitigate customer attrition, or increase the quality of information associated with intent (e.g., increase the instances in which intent is conveyed via explicit rather than implicit expression). In yet another aspect, compensation component 135 can broker partnerships with disparate online or offline merchants that may be affiliated with service platform 110.

It is to be appreciated that through a set of registered mobile devices (e.g., devices 412₁-412_{N}), compensation component 135 can provide compensation either online or offline. Registration of devices that can receive compensation facilitates the optimization of a device's resources when conveying an advertisement that carries compensation. Furthermore, a set of devices that are utilized at the time an eligible action is undertaken by agent 410 can drive the compensation type. For example, agent 410 utilizes an online service to trade stocks (a possible embodiment of service platform 110) in a laptop computer (e.g., device 412₁) while the agent 410 listens to music in a Zune® digital media player—that agent 410 is listening music in a Zune® device (e.g., device 412_{N}) can be gleaned from information collected by webcam operating on the agent's laptop computer and conveyed to intent processing component 435—at a specific instance agent 410 buys stock from an entertainment company. The system platform, based on the transaction, available intelligence about the user, and the fact that the user is listening to a Zune® device, result in a digital song delivered to the user email inbox (and possibly a notification to the agent's cell phone) as a compensation for conveying intent to the stock trading system. The illustrative scenario described hereinbefore displays a central advantage of the intent-compensation price incentive scheme herein disclosed with respect to conventional system: Compensation can be synergistically customized based on context and behavior, rather than established solely on user intelligence or eligible action.

As illustrated above, compensation 165 has monetary value. Monetary value can be effected (i) directly, e.g., monies are deposited in a compensation account 420 that belongs to agent 410, or debt carried by agent 410 in, for example, credit card(s) is reduced by a specific amount—it should be appreciated that such credit card(s) can be issued or managed by service platform 110 or an affiliated lender (e.g., service provider) which makes debt reduction substantially more affordable and advantageous to the service platform 110. Direct payments can be electronic and effected in real time, via a wireless transmission effected through communication 418 directly to a debit/credit card registered by agent 410. The magnitude of a direct payment awarded to agent 410, as compensation 165, is generally a function of multiple variables: enrollment longevity, income bracket, educational level, professional activities, leisure activities, and demographics factors. Based at least in part on such parameters, compensation component 135 can determine an adequate compensation for agent 410. It is to be appreciated that agent 410 can be notified to one or more of the agent's registered devices that a direct payment incentive has been awarded; for example, in an online interaction a user can receive an instant message describing the type and magnitude of the compensation, or in an offline interaction the user can receive a short message service (SMS) message to the agent's cell phone, pager, or any other registered device (e.g., device 412₁-412_{N}).

Monetary value can also be effected (ii) indirectly, such as through reward points, service-specific points, platform-specific points, virtual monies or points, e.g., Microsoft® Points or substantially any other denomination, that can be used to claim a rewards either online or offline. In addition, agent 410 can be compensated with generic points (or substantially any other tokens associated with materializing a compensation) that facilitate claiming products or merchandise of different types and scope. Points, generic or otherwise, can be perishable or perennial, and can be transferred to a second agent (not shown). It should be appreciated that, in an aspect, generic points can be managed dynamically by service platform 110, adopting promotional value to drive a specific product or service campaign, or changing scope as a function of the point bearer (e.g., a compensated agent like agent 410). An alternative or additional form of indirect monetary compensation can be effected through digital merchandise like songs; ring-tones; movies; pictures; books; magazine articles, technical or otherwise; greetings cards; games, console-based and online, single-player or multiplayer; software application add-ons such as Microsoft® Visio® stencils or custom font sets; foreign-language dictionaries; maps, secret passages, and answers to riddles for second worlds relevant to role playing games, and so on.

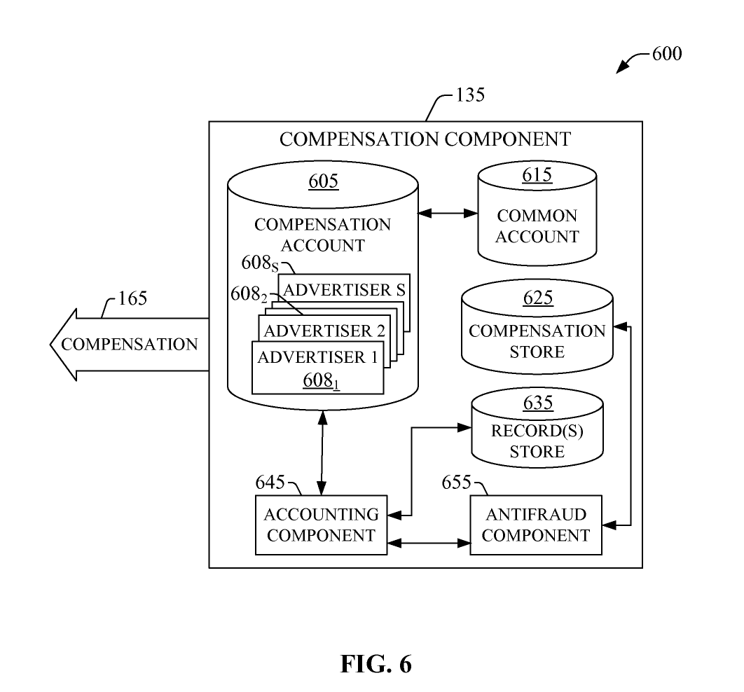

FIG. 5 is a block diagram of an example embodiment of CPA advertisement management component 128 that facilitates compensation credit(s) 150 generation and advertisement delivery according to aspects described herein. Illustrative CPA advertisement management component 128 comprises an ad spend management component 505 that receives and manages advertisement spending 145 from advertisement engine 170. As discussed above, a portion of the received ad spend 185 results in internal arbitrage profit 150 and is directed to compensation credit(s) 150 for an advertiser to compensate an agent 410 in exchange for the agent's intent in engaging in a transaction with service platform 110. In example embodiment 500, CPA advertisement management component 128 also includes an optimization component 515 that (i) adjusts advertisement content delivered to an agent, and (ii) optimizes advertisement format in accordance with a registered device utilized by an agent that conveys intent 415 to the service platform 110. It is to be appreciated that optimization of advertisement format according to the media resources of a particular device (e.g. a device with limited display real state, or a device with limited sound capabilities such as a navigation system) provides agent 410 with the richest advertisement experience available to the device and thus increases the likelihood that the agent responds to the advertisement by effecting an action. The latter justifies at least in part the selection of CPA as pricing model for advertisement.

Optimization of advertisement format and delivery can rely on input provided by ad response analysis component 525, which can monitor response metrics for the agent when presented with a specific type of advertisement. For example, it can be determined that an agent is more likely to effect an advertisement-driven action (e.g., respond to a survey, follow a link to a beta release of a website, buy a merchandise) when the presented advertisement contains age-appropriate music or sound indicia rather than when the advertisement is solely based on imagery. As another example, it can be measured that an agent responds more favorably to advertisement instantiation when cinema, television, or music stars appear on the delivered advertisement endorsing a product or service. As yet another example, typically at check out, a cashier at a supermarket issues paper coupons for specific merchants based on the purchased goods, while for a segment of customers paper coupons are useful for a disparate segment, e.g., early adopters of advanced technology, a soft version of the coupon can increase likelihood of coupon redemption; accordingly, in an aspect of the subject innovation, advertisement response analysis component 525 can gather information via a set of cameras and microphones deployed at the cashier in the example above, while an analysis component (not shown) can identify the customer with a specific customer segment, subsequently a coupon format optimized for the customer segment is delivered; e.g., an indication to print a coupon is conveyed to the cashier or a coupon is wirelessly conveyed to customer's smart phone. In addition, information gathered through advertisement response analysis component 525 can be stored in data store 555 and provided (e.g., sold) to advertisers within advertisement engine 170.

It is to be appreciated that optimization component 515 can autonomously generate new advertisement content leveraging off existing content in ad content store 535. Generation of new ad content can be driven by analysis provided by ad response analysis component 525 and data on advertisement transactions, e.g., transaction intelligence 245, and conversions among pricing models. Generation of digital ad content can exploit metadata adaptation of existing advertisement content or edition (e.g., addition of a soundtrack, icons, images, etc.) of such content

CPA advertisement management component also includes an ad display component 545 that presents an agent (e.g., agent 460_{M}) with intent-compensation incentive advertisement. Advertisement conveyed through ad display component 545 can be rendered at stationary offline points or on substantially any device utilized by the agent and registered with the service platform 120. Displayed advertisements can present a compensation flag (e.g., 548_{K}) or an exact-rebate-value (e.g., 548_{J}) flag. It is to be appreciated that rebated value can be adapted to specific characteristic of agent 410 to which the advertisement is presented. Advertisements can be conveyed in multiple formats (e.g., image-based (e.g., banners), text-based, sound-based, or a combination thereof) depending on the media resources available to the device (not shown) in which the advertisement is rendered, or available to an advertisement “dock” (e.g., an outdoor electronic banner) for display of intent-compensation advertisements offline. In one embodiment, ad display component 545 can be employed to notify agent(s) 410 of compensation trade opportunities, or advertised compensation after agent(s) 410 no longer utilizes service platform 11. Such embodiment adds value for the service platform 120 and advertisers within advertisement engine 170 as it increases the lock-in of the user with the service platform 110 by increasing the likelihood of repeat engagements, in which new advertisements and trade opportunities can be presented to agent 410.

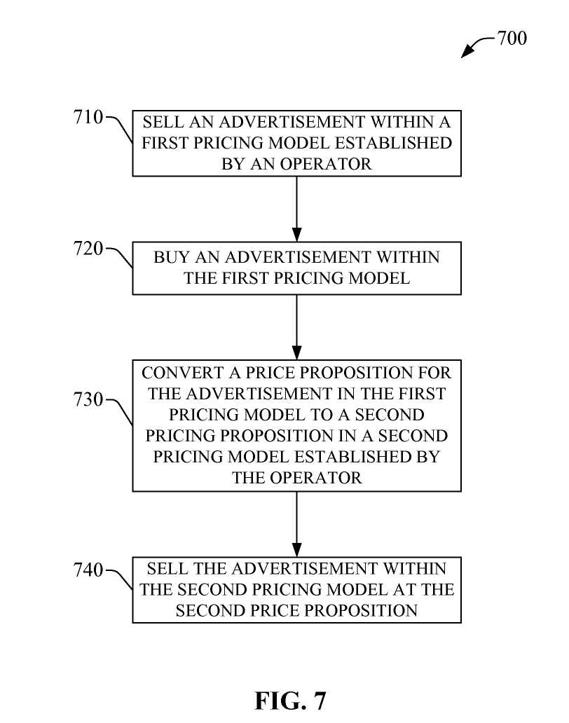

FIG. 6 is a block diagram of an example embodiment 600 of compensation component 135 which comprises compensation account 605 and common account 615; funds can be transferred from the former to the latter in transfer cycles with specific time periods determined by CPA ad management component 128. Specific compensation can be stored in compensation store 625. It is to be noted that compensation 165 made available through component 135 typically has monetary value; thus, to ensure compensation is adequately awarded, accounted for, and recorded, compensation component 135 includes an accounting component 645, an antifraud component 655, and a records store 635.

Accounting component 645 can account for payments, retain compensation records in record(s) store 635, and monitor a current level of compensation to ensure, for example, compensation fails to surpass a compensation limit established by an advertiser that issues the compensation. In an aspect, when compensation issued by an advertiser are points (e.g., generic points, reward point, or platform specific points lime Microsoft® Points), accounting component 645 can conduct the accounting thereof. In addition, compensation event(s) can be recorded by accounting component 645. Generally, compensation records can include type and amount of compensation delivered and can augment available intelligence on agent 410. Retaining records of delivered compensation facilitates to resolve disputes that can arise from fraudulently awarded compensation. In a dispute, service platform 110 can start an audit of a reward transaction to confirm its veracity.

Antifraud component 655 manages security features that mitigate fraudulent exploitation of compensation and preserve compensation records integrity. Antifraud component can exploit various resources such as advertiser intelligence 225, data stored in memory 316, optimization component 215, and so forth. Moreover, antifraud component 655 can implement detection of biometric markers (e.g., voice signature, face-feature recognition like recognition of scars, moles, freckles, eye color and iris structure, and so on) in online and offline compensation that can facilitate biometric-based verification to ensure that an intended customer indeed received an intended compensation. Antifraud component 655 can provide substantially all functionality associated with probing biometric features (e.g., cameras for bio-feature recognition, fingerprint pads, iris scanners . . . ), encrypting/decrypting online compensation, etc; yet, utilization of resources available to other system components can also be exploited. In an aspect, antifraud component 655 can mitigate fraudulent compensation by systematically reducing the face-value of delivered compensation for reiterative engagements with an enrolled advertiser (e.g., advertiser 178_{S}) that is determined, for example via optimization component 215, to be likely fraudulent. A characteristic relaxation time for compensation value can be determined by antifraud component in conjunction with an enrolled advertiser, for example, according the degree of confidence on the illegitimate nature of substantially any transaction with the enrolled advertiser that leads to a rebate.

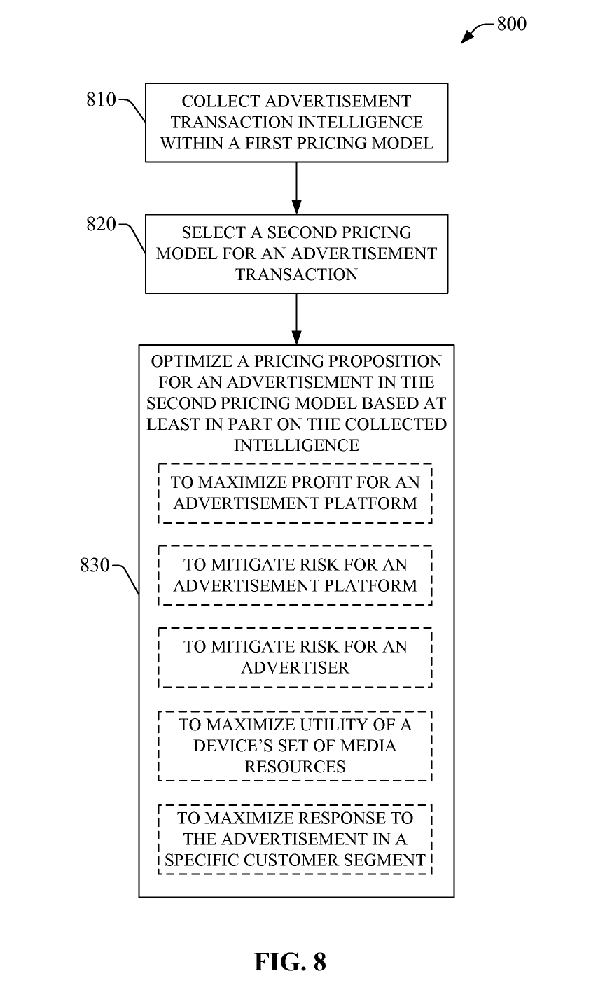

In view of the example systems, and associated aspects, presented and described above, methodologies for effecting internal arbitrage within an organization that may be implemented in accordance with the disclosed subject matter can be better appreciated with reference to the flowcharts of FIGS. 7-10. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 7 is flowchart of an example method 700 for performing an internal business arbitrage according to aspects disclosed in the subject specification. It is to be noted that method 700 utilizes an advertisement as a tradable instrument for arbitrage; however, substantially any tradable entity with financial worth can be the object of internal arbitrage as described herein. At act 710, an advertisement is sold within a first pricing model established by an operator. The operator typically is a service platform, e.g., service platform 110, or it can be substantially any entity (e.g, an organization) that possesses tradable goods with financial worth. At act 720 an advertisement is bought within the first pricing model. At act 730 a price proposition for the advertisement in the first pricing model is converted to a second pricing proposition in a second pricing model established by the operator. It should be appreciated that the first price proposition is typically the price paid to acquire the advertisement within the first pricing model. At act 740, the advertisement is sold within the second pricing model at the second price proposition.

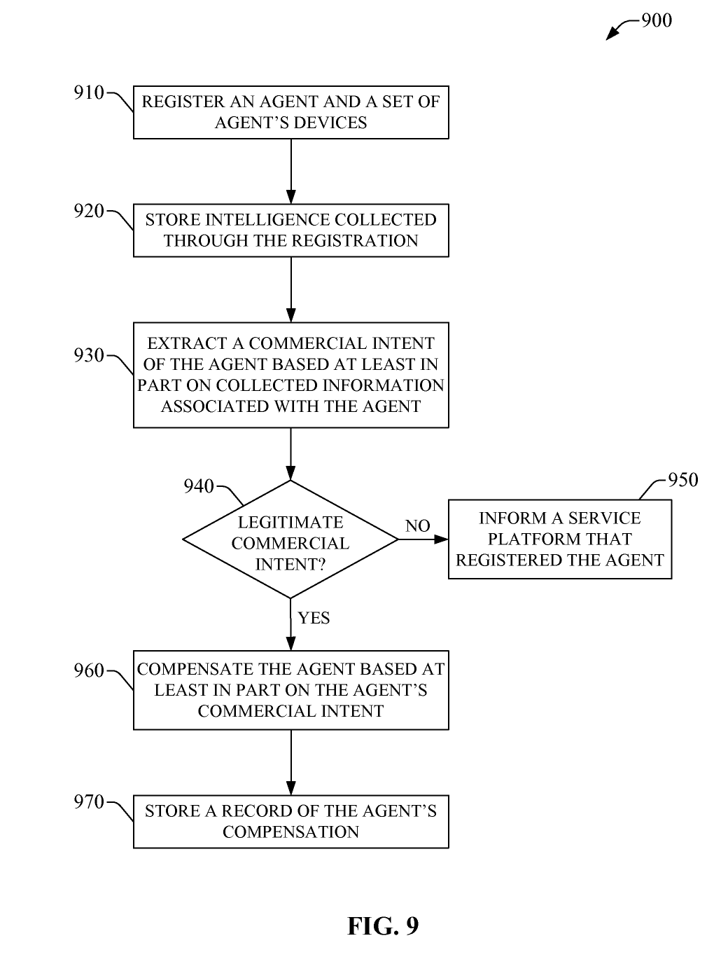

FIG. 8 is a flowchart of an example method 800 for converting a first price proposition in a first pricing model to a second pricing proposition in a second pricing model according to aspects described herein. At act 810, advertisement transaction intelligence within a first model is collected is collected. At act 820, a second pricing model is selected for an advertisement transaction. It is to be noted that in acts 810 and 820, advertisement transaction refers to a purchase or sale of advertisement space, or advertisement rights, or specific advertisement format or indicia. With respect to online advertising various pricing models can be considered such as “cost per click,” (CPC) “cost per action” (CPA), “cost per impression” (CPI), and so on. CPI is also referred herein via the conventional terminology CPM (cost per mille). Such pricing models generally ensue different levels of financial or commercial risk to an advertiser and to an advertiser platform; risk on this constituents in reciprocated; in other words, the highest risk for an advertiser carries the lowest risk for an advertiser platform. For example, CPC exposes an advertisement platform to the least risk, whereas CPI poses the most. The relationship among risk and pricing model is converse for the advertiser. At act 830, a pricing proposition for an advertisement in the second pricing model is optimized based at least in part on the collected intelligence. Optimization can be effected with respect to various economic objectives; for instance, to maximize profit or mitigate risk for an advertisement platform, to mitigate risk for an advertiser, to maximize utility of a device's set of media resources, to maximize response in a specific customer segment, and so on.

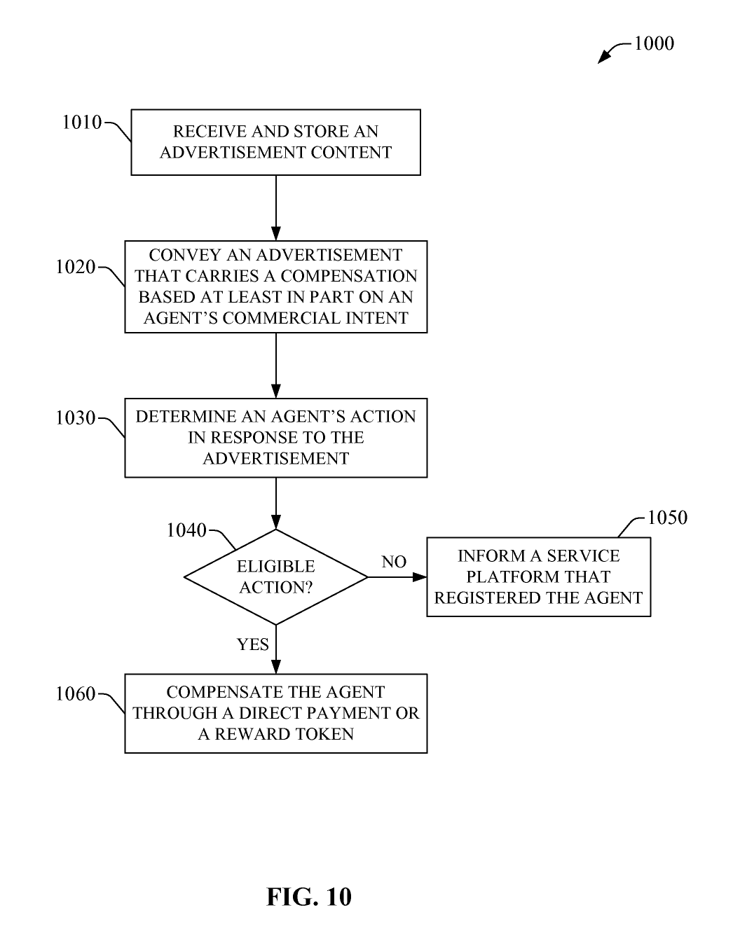

FIG. 9 illustrates an example method 900 for compensating an agent in exchange of the agent's commercial intent. Generally, compensation is provided by a service platform that provides a service or merchandises a product. Service(s) or product(s) can be delivered online or offline. Similarly, agent's intent can be conveyed online or offline, gleaned from implicit or explicit expressions or actions. At act 910, an agent and a set of devices that belong to the agent are registered. Typically registration is with a service platform with which the agent intends to conduct a commercial transaction. At act 920, information provided by the agent, or agent intelligence, is stored. Such information can facilitate intent determination, in particular in situations in which agent's intent is inferred through collection of implicit expressions of intent (e.g., standing in line in a movie theater, or waiting in the lobby of a restaurant, parking outside a supermarket store, etc.) At act 930, a commercial intent of the agent is extracted based at least in part on collected information associated with the agent. At act 940, the veracity of legitimacy of the agent's commercial intent is validated. When the validation act indicates intent is fraudulent, a service platform that has registered the agent is informed at act 950. Generally, the information can be utilized to flag the agent and collect further information associated with illicit intent, or in order to penalize the agent in future engagements with the service platform. Legitimate intent results in agent's compensation based at least in part on the agent's intent at act 960. At act 970, a record of the compensation is stored. The compensation record increases intelligence accumulated on the user, facilitates auditing claims associated with missed compensation, etc.

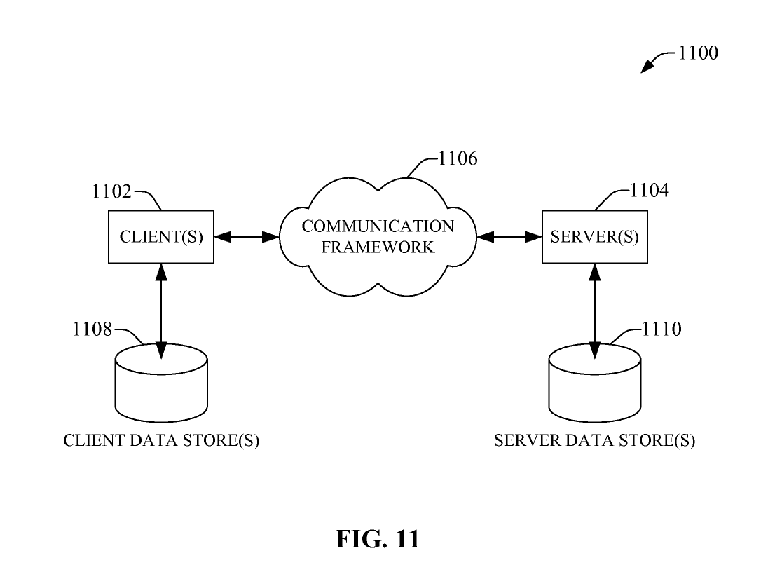

FIG. 10 presents a flowchart of an example method for compensating an agent through advertisement in exchange of agent's intent in transacting with a service platform. At act 1010 an advertisement content is received and stored. At act 1020, an advertisement that carries compensation (e.g., Ad J 548_{J} or Ad K 548_{K}) is conveyed, wherein the compensation is based at least in part on an agent's commercial intent. In an aspect, compensation is funded through advertisement spend originated by an advertisement engine (e.g., advertisement engine 170). The advertisement engine can be a part of a service platform with which the agent interacts commercially, can be a conglomerate of advertisers managed by an advertisement agency that manages and maintains the advertisement engine, or it can be a portion of a content, product or service provider affiliated with the service platform. It should be appreciated that either the advertisement agency or the affiliated provider can run business operations exclusively offline or exclusively online. Alternatively, or in addition, advertisers can be associated with online business operations. It is to be appreciated that regardless the nature of the business operations in connection with the advertisement engine, an advertisement management component can administer advertisement online or offline.

At act 1030, an agent's action is determined in response to the conveyed advertisement. The advertisement can indicate the agent that an action is required in order to receive a compensation (e.g., advertisement-driven-action-to-compensation model). Alternatively, compensation can be delivered through advertisement exposure or advertisement instantiation (e.g., the agent opens a link to the advertisement, opens a message carrying the advertisement, received a call for a “sales pitch” advertisement, . . . ).

At act 1040, the action is checked in order to determine whether the agent has engaged according to the advertisement model (e.g., exposure, instantiation, action) for compensation. When the agent fails to act accordingly, a service platform that registered the agent is informed at act 1050. In an aspect, receiving such information provides the service platform to adjust or optimize advertisement content or delivery in order to promote agent lock-in with the action proposed in the advertisement. At act 1060, an agent that performs an eligible action is compensated through either a direct payment (e.g., deposit in a bank account, retirement account, college savings account, credit card account, brokerage account, college/school/childcare tuition account, and so on), or via a reward token like reward points or point currency, digital goods or content, coupons for offline or online stores, and the like.

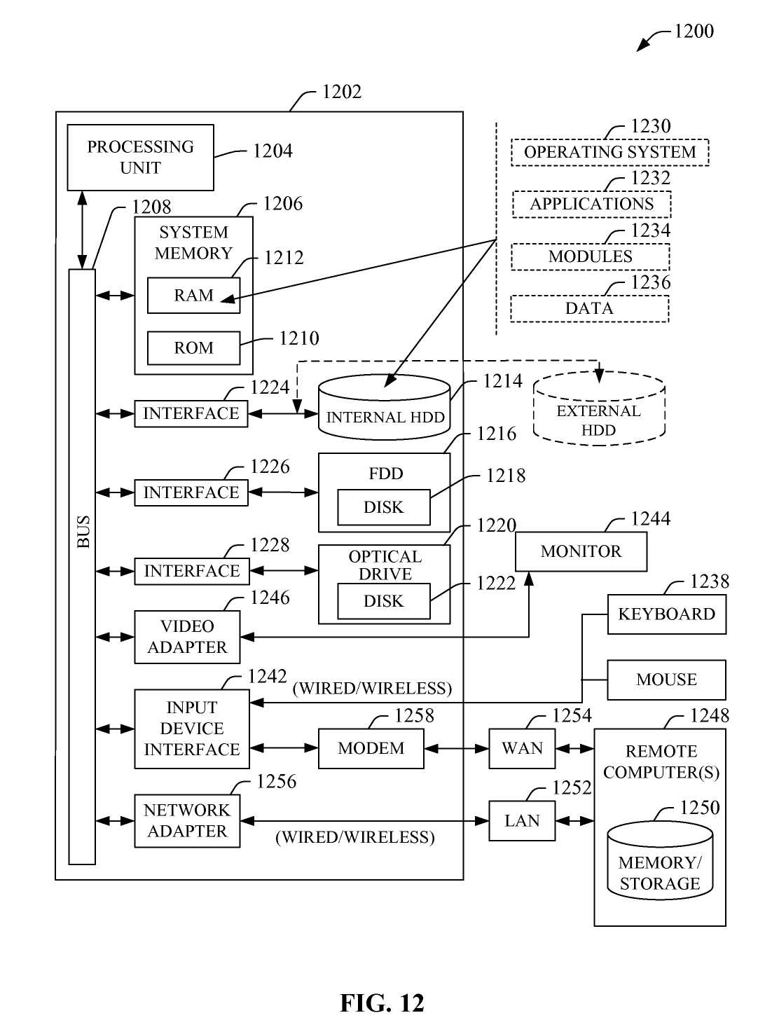

In order to provide additional context for various aspects of the subject specification, FIGS. 11 and 12 and the following discussions are intended to provide a brief, general description of suitable computing environments 1100 and 1200 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

FIG. 11 illustrates a schematic block diagram of a computing environment in accordance with the subject specification. The system 1100 includes one or more client(s) 1102. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware and/or software (e.g., threads, processes, computing devices). The servers 1104 can house threads to perform transformations by employing the specification, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

In FIG. 12, the example environment 1200 for implementing various aspects of the specification includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the specification can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 408 via an interface, such as a video adapter 1246. In addition to the monitor 444, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are example and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “has,” “possesses,” and the like are used in either the detailed description or the claims, such term is intended to be inclusive in a manner similar to the term “comprising” as “comprising” is interpreted when employed as a transitional word in a claim.

What is claimed is:

1. A system that facilitates internal arbitrage of a first price model and a second price model, the system comprising:
a service component that sells an advertisement within a cost-per-click price (CPC) price model, the service component operates within a service platform;
a component that buys the advertisement within the CPC price model and sells the advertisement within a cost-per-action (CPA) model, the component operates with the service platform; and
a conversion component that converts a CPC price proposition to a CPA price proposition to facilitate the sale of the advertisement.

2. The system of claim 1, wherein the service component sells an advertisement within a cost-per-impression (CPM) price model.

3. The system of claim 2, further comprising:
a component buys the advertisement within the CPM price model and sells the advertisement within a CPA model; and
a component converts a CPM price proposition to a CPA price proposition to facilitate the sale of the advertisement.

4. The system of claim 1, further comprising a profit account that stores arbitrage profits from the sale of the advertisement.

5. The system of claim 1, wherein the conversion component includes a bid management component that maps “clicks” volume for an advertisement unit to a likelihood of an “action” for the advertisement unit to derive a converted price proposition.

6. The system of claim 5, wherein the conversion component includes an optimization component that infers an optimal converted price proposition and an algorithm store that facilitates the optimization.

7. The system of claim 1, further comprising a memory that stores advertisement transaction intelligence.

8. The system of claim 4, wherein the arbitrage profits subsidize at least in part a consumer compensation program.

9. The system of claim 1, further comprising a component that awards a compensation, the component includes:
a component that accounts awarded compensation;
an antifraud component that mitigates fraudulent compensation; and
a component that retains compensation records.

10. The system of claim 1, further comprising:
a component that registers an agent and a set of devices operated by the agent;
a component that extracts intent from received information associated with the registered agent; the information received at least in one of an offline domain or an online domain;
a component that compensates the agent via advertisement spend in return for the extracted agent's intent.

11. A method for conducting internal business arbitrage, the method comprising:
selling an advertisement within a first pricing model established by an operator;
buying an advertisement within the first pricing model;
converting a first price proposition within the first pricing model to a second price proposition in a second pricing model established by the operator; and
selling the advertisement within the second pricing model at the second price proposition.

12. The method of claim 11, the first pricing model is one of a “cost per click” (CPC), “cost per action” (CPA), “cost per impression” (CPM).

13. The method of claim 12, the second pricing model is one of a “cost per click” (CPC), “cost per action” (CPA), “cost per impression” (CPM).

14. The method of claim 13, further comprising:
collecting intelligence on a set of advertisement transactions within a first pricing model; and
selecting a second pricing model for an advertisement transaction; and
optimizing a pricing proposition for the advertisement transaction in the second pricing model based at least in part on the collected intelligence.

15. The method of claim 14, further comprising optimizing a pricing proposition for the advertisement transaction in the second pricing model to maximize at least one of a profit for an advertisement platform, a utility of a device's set of media resources, or a response to advertisement in a specific customer segment.

16. The method of claim 13, further comprising mapping “clicks” volume for an advertisement unit to a likelihood of an “action” for the advertisement unit to derive a converted price proposition

17. The method of claim 11, further comprising acts for intent-based compensation of an agent in exchange for the agent's intent in transacting with a service platform, the acts including:
registering an agent;
extracting a commercial intent of the registered agent through at least one of a set of offline expressions or a set of online expressions;
assessing the legitimacy of the extracted commercial intent;
compensating the registered agent in exchange for the agent's legitimate commercial intent.

18. The method of claim 17, compensating the registered agent in exchange for the agent's legitimate commercial intent further comprising:
conveying an advertisement that carries a compensation based at least in part on the agent's commercial intent;
determining an agent's action in response to the advertisement;
determining the agent's action is an eligible action based at least in part on the advertisement's content; and
compensating the agent through at least one of a direct payment or a reward token.

19. The method of claim 17, conveying an advertisement that carries a compensation based at least in part on the agent's commercial intent further comprising:
receiving a payment to display the advertisement;
allocating a portion of the payment to compensate an agent based at least in part on an agent's commercial intent; and
delivering an advertising associated with the agent's commercial intent.

20. A computer-readable medium having code instructions stored thereon that, when executed by a computer, cause the computer to perform the following acts:
selling an advertisement within a first pricing model established by a service platform;
buying an advertisement within the first pricing model;
converting a first price proposition within the first pricing model to a second price proposition in a second pricing model established by the service platform; and
selling the advertisement within the second pricing model at the second price proposition for a profit.
